(19) United States
(12) Patent Application Publication
(10) Pub. No.: US 2025/0274336 A1
(43) Pub. Date: Aug. 28, 2025

(54) MULTIPLE AGENT AUTOMATIC ROOT CAUSE ANALYSIS

(71) Applicant: eBay Inc., San Jose, CA (US)

(72) Inventors: Hao Chen, Santa Clara, CA (US); Kun Liu, Shanghai (CN); James Tong, Santa Clara, CA (US); Jierui Wang, Shanghai (CN); Zhaohui Xu, Shanghai (CN); Sami Ben Romdhane, Los Altos, CA (US); Venkata R. Yella, San Jose, CA (US)

(73) Assignee: eBay Inc., San Jose, CA (US)

(21) Appl. No.: 18/584,712

(22) Filed: Feb. 22, 2024

(51) Int. Cl. H04L 41/0631; H04L 41/16

(52) U.S. Cl. CPC H04L 41/0631; H04L 41/16

(57) ABSTRACT

Multiple agent root cause analysis techniques are described. In an implementation, a processor performs operations to troubleshoot performance of a system operation by a plurality of domains (e.g., of a distributed system). The processor executes a system artificial intelligence (AI) agent to determine which domains of the plurality of domains include domain functions in support of the system operation, and to generate, using machine learning, queries to the determined domains based on the system operation. Domain responses are received from domain AI agents associated with the determined domains responsive to the queries and generated based on domain data associated with respective domains. A system response is generated by the system AI agent using machine learning based on the domain responses.

### BACKGROUND

Distributed computing systems perform system operations by invoking different functions that are executed across multiple domains. Each domain includes a collection of computing resources (e.g., machines, systems, servers, workstations, devices, processors) to separately handle different functional dependencies of the system operations. Domain resources operate according to a common set of rules or policies that are specific to that domain; this helps organize, secure, and manage complex interactions and functional dependencies that arise from implementing the system operations. Accordingly, conventional techniques tasked with troubleshooting performance of the dependent functionality typically involves individual checks within each domain, e.g., one at a time. Multiple investigators, for instance, often collaborate as part of conventional techniques to analyze and resolve a single issue, each employing specialized knowledge and privileges within respective domains. As a result, performance of conventional techniques tasked with troubleshooting performance involve significant amounts of resources over a significant amount of time, which is inefficient with corresponding high maintenance costs and user dissatisfaction.

### SUMMARY

Multiple agent root cause analysis techniques are described. In an implementation, a multi-agent service is configured to troubleshoot system operations of a distributed system, automatically and without user intervention. To do so, the service utilizes a multi-agent platform that includes domain artificial intelligence (AI) agent modules and a system AI agent module to coordinate the domain AI agent modules arrival at a goal.

Each domain AI agent module, in one or more examples, is trained or retrained via machine learning using domain data that is specific to that domain. Once trained or retrained by the domain data, each domain AI agent module is operable to generate domain responses to domain queries. A domain response indicates performance of a dependent function (i.e., a domain function) implemented by that domain in furtherance of a system operation mentioned in the domain query. In some implementations, the domain response implicates other dependent functions of the system that are implemented by other domains.

The system AI agent module, in one or more examples, is likewise trained or retrained via machine learning to respond to user queries it receives for troubleshooting issues with a system operation. In response to receipt of a user query, the system AI agent module generates one or more domain queries for receipt by the domain AI agents. Each domain query is configured to troubleshoot performance of a dependent function of the system operation as it pertains to that domain. The system AI agent is further trained or retrained via machine learning to interpret the domain responses received from the domain AI agents in reply to the domain queries to output a query response indicating one or more causes of the issues mentioned in the user queries.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

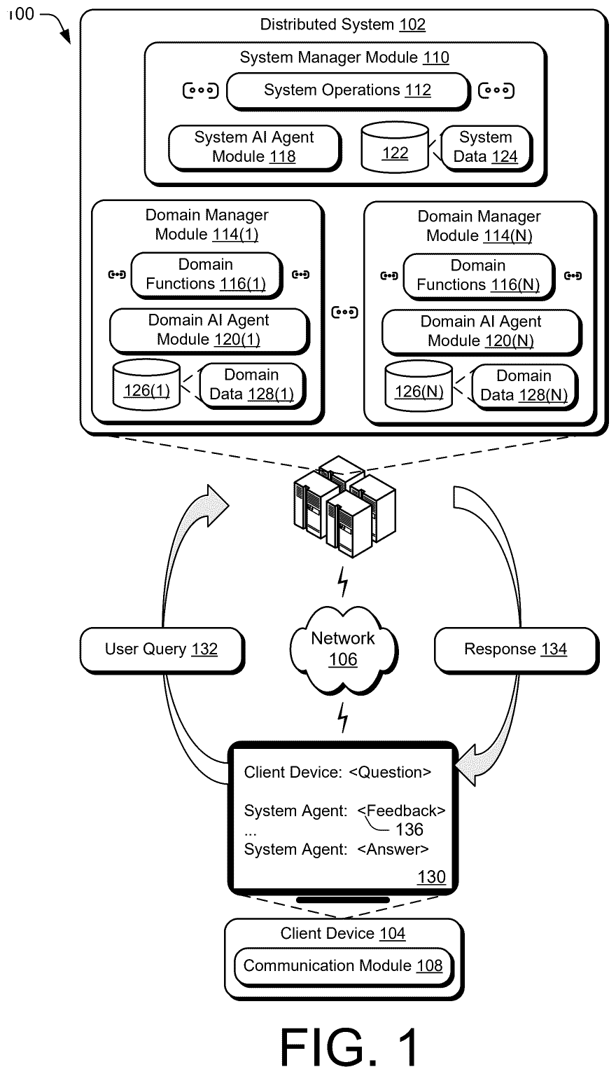

FIG. 1 is an illustration of an environment in an example implementation that is operable to employ multiple agent automatic root cause analysis techniques described herein.

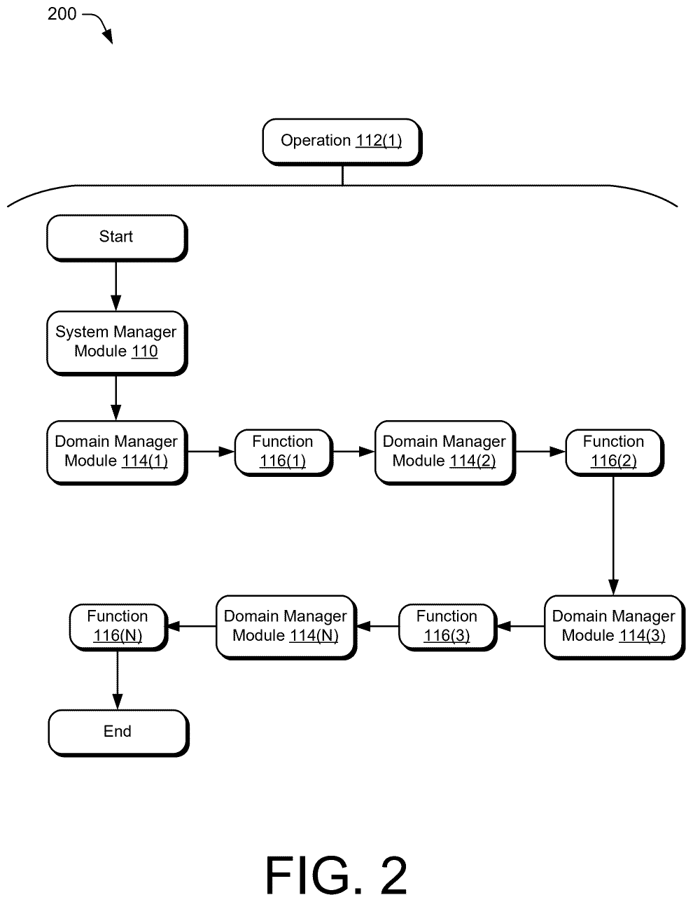

FIG. 2 depicts an example dependency tree of domain functions that support execution of a system operation performed by a distributed system as described herein.

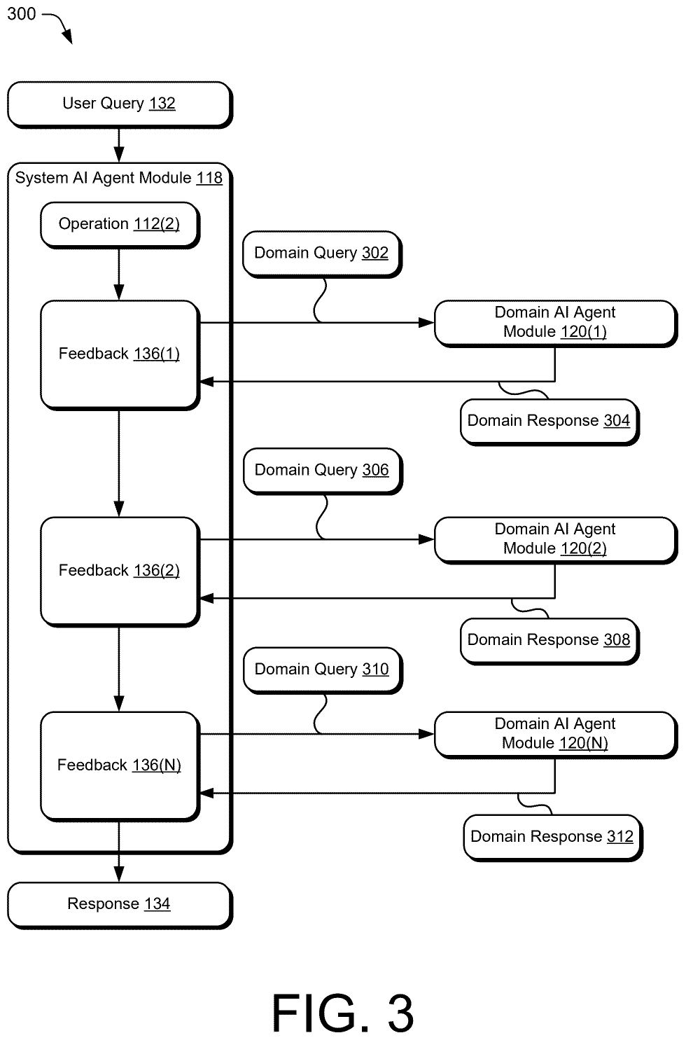

FIG. 3 depicts a system in an example implementation showing tasks of a system agent and a plurality of domain agents that are operable to employ multiple agent automatic root cause analysis techniques as described herein.

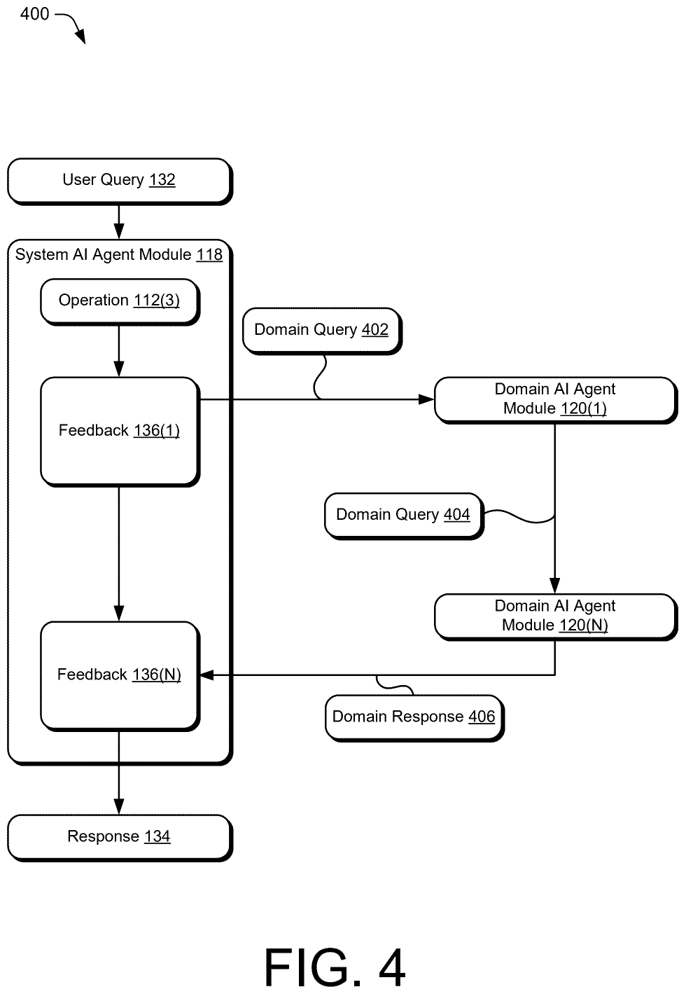

FIG. 4 depicts a system in another example implementation showing tasks of a system agent and a plurality of domain agents that are operable to employ multiple agent automatic root cause analysis techniques as described herein.

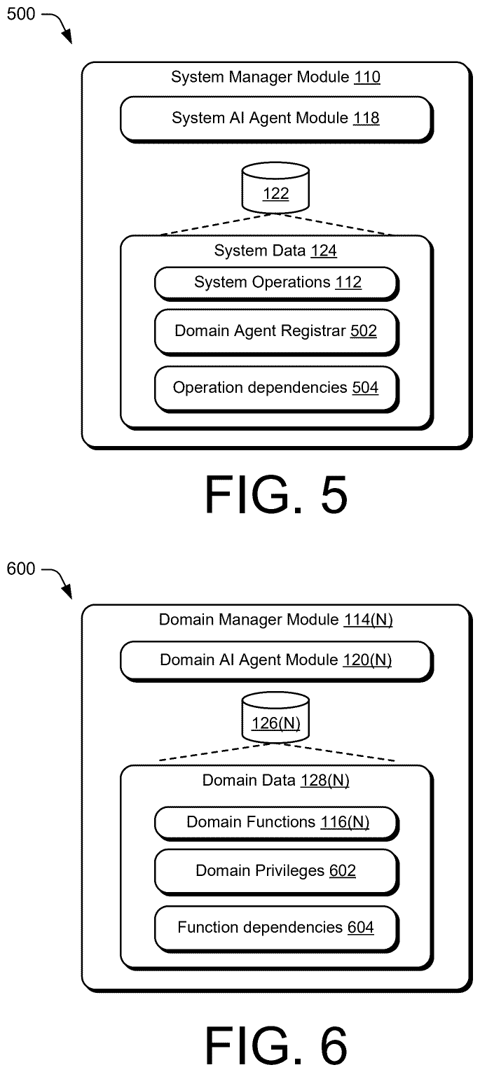

FIG. 5 depicts a system in an example implementation showing a system agent of FIG. 1 in greater detail.

FIG. 6 depicts a system in an example implementation showing a domain agent of FIG. 1 in greater detail.

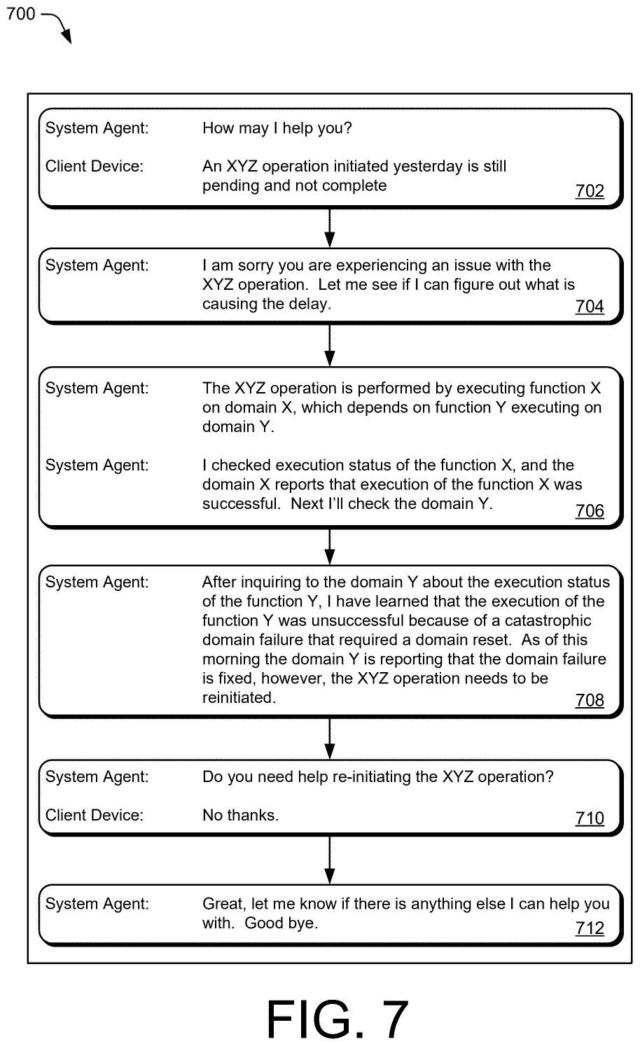

FIG. 7 illustrates an example user interface showing interactions between a client device and a system agent that is operable to employ multiple agent automatic root cause analysis techniques as described herein.

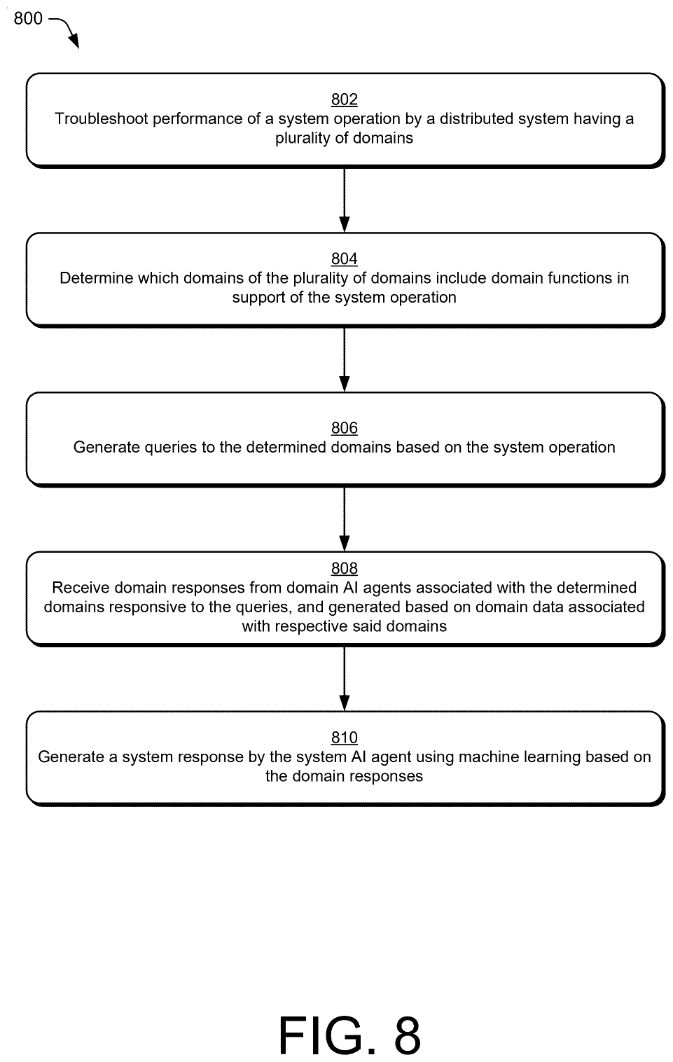

FIG. 8 is a flow diagram depicting a step-by-step procedure in an example implementation of tasks performable by a processing device for implementing multiple agent automatic root cause analysis techniques as described herein.

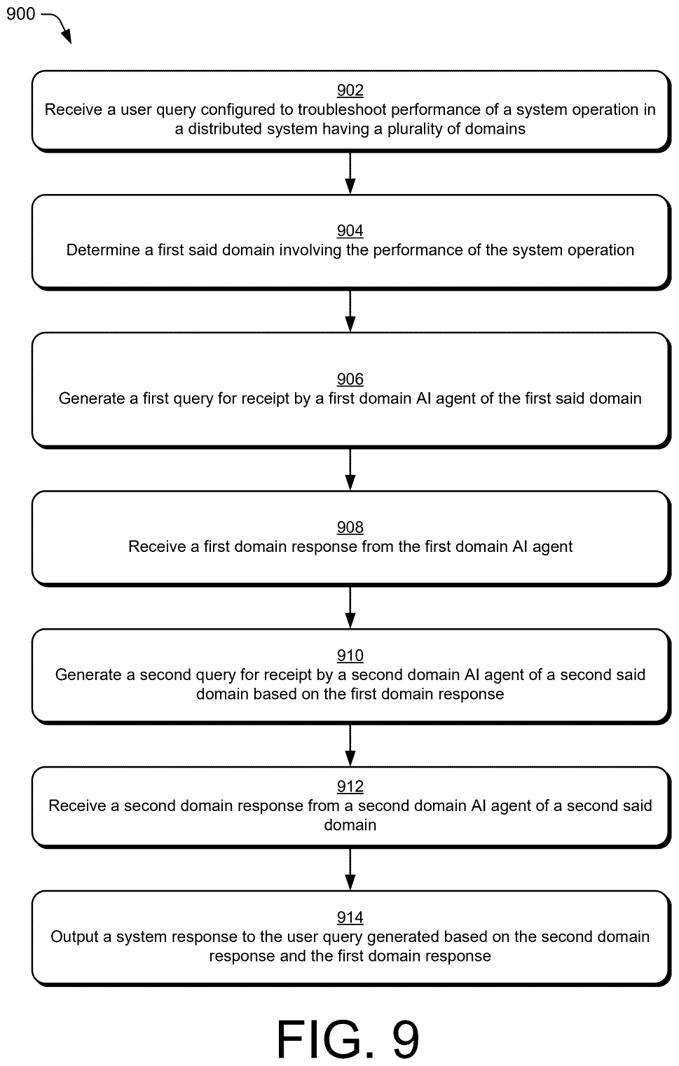

FIG. 9 is a flow diagram depicting a step-by-step procedure in an example implementation of tasks performable by a processing device for implementing multiple agent automatic root cause analysis techniques as described herein.

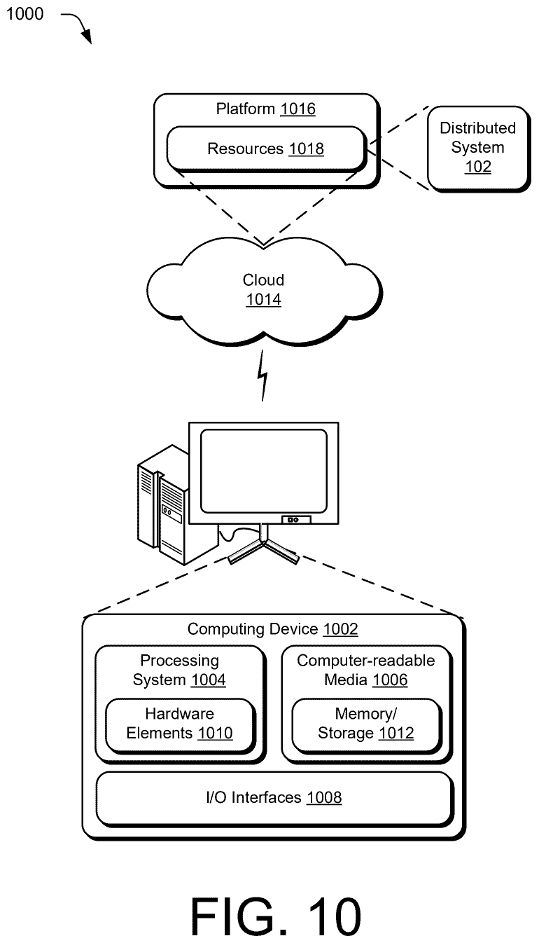

FIG. 10 illustrates an example system including various components of an example device that can be implemented as any type of computing device as described and/or utilize with reference to the previous figures to implement embodiments of the techniques described herein.

### DETAILED DESCRIPTION

### Overview

A distributed system is typically configured using multiple computing resources, which communicate and coordinate over a network, to execute dependent functions that support system operations. A topology of a distributed system groups logically related computing resource into several computing domains. Each domain encompasses at least one computing resource (e.g., machine, system, server, workstation, device, processor) that is configured to execute dependent functions to support execution of at least one system operation. The computing resources of each domain operate according to a common set of rules or policies that are specific to that domain. Grouping computing resources of a distributed system into different domains can facilitate organization, security, and management of complex interactions and functional dependencies that occur when system operations are implemented.

System operations performed on distributed systems often rely on multiple domain functions; a system operation may depend on multiple domain functions that execute sequentially or in parallel. Some domains are redundant to promote reliability and reduce system down time when issues arise. For example, when a first domain is not satisfying performance conditions of a distributed system, a system operations relies instead on a second domain for its domain functionality. Other domains are distinct. For example, a first domain is configurable to execute a first function to register a new profile in furtherance of a system operation. The registration function then relies on a second domain to execute a second function in furtherance of the same system operation to set parameters for initializing the profile.

A technical benefit to having individual domains within a distributed architecture is that the individual domains can be siloed from each other, thereby isolating the domains from each other, and improving security. For example, each domain is configurable to have a different set of privileges across the system so a malicious actor with access to one domain cannot access another, restricted domain. Domain isolation also improves performance. For example, each distinct domain is configurable to further a different set of domain functions for the system operations.

While several benefits are attributable to a distributed architecture, the distributed nature of domain functions that support each system operation causes complexity in evaluating performance. Manually troubleshooting performance of a distributed system, for instance, can involve individually checking functionality of each domain (e.g., sequentially one at a time) to identify a root cause. Performance of the first domain function, for example, is evaluated separate from performance of the second domain function. In some scenarios, however, technical challenges are encountered in identifying which domain and/or which specific function to check.

An investigator with expertise at debugging some domains of the distributed system, for instance, may lack an understanding and/or access to privileges usable to investigate other domains. Therefore, in some conventional scenarios multiple investigators, each with specific knowledge of a different domain, are tasked with collaborating to identify a source of a system level problem. Debugging distributed systems in this way can be time consuming and expensive in real world scenarios. Complex and/or delayed resolutions to an operational issue in a distributed system decrease user satisfaction and increase maintenance and support costs.

Accordingly, to address these and other technical challenges associated with managing distributed systems, automated multiple agent root cause analysis techniques are described. The described techniques enable an artificial intelligence (AI) platform to provide various services (e.g., streamlined workflow automations, root cause analysis, anomaly detection, and healthy remediation) that connect multiple expert knowledge sources within a distributed system that improves operational efficiency of the system.

In an implementation, a distributed system includes multiple computing domains. Each domain of the distributed system executes different functions in furtherance of respective system operations. The distributed system also includes a plurality of artificial intelligence (AI) agents configured to collaborate towards identifying possible causes for problems experienced during execution of system operations. In general, an AI agent executes in an intelligent manner to perceive an operating environment, and autonomously perform actions that achieve goals. An AI agent may improve performance by acquiring knowledge through training, retraining, and/or machine learning of a machine-learning model.

In an implementation, at least one of the AI agents is configured as a system (or global) AI agent. The system AI agent is configurable to implement a variety of functionalities. Examples of these functionalities include an ability to execute operations to achieve a goal (e.g., to determine an answer to a user query), understand and breakdown questions, and to orchestrate tasks among other AI agents of the distributed system. Each of these other AI agents is configured as a domain (or function) AI agent in this example. The domain AI agents are registered with the system AI agent for use as domain level experts that have detailed and specialized knowledge about specific functions performed by their specific domains in furtherance of various system operations. Each domain AI agent is configured to answer queries using expert level domain knowledge and understanding of different domain states including resource states, workflow statuses, logs, metrics, alerts, and so forth.

The system AI agent executes a large language model (LLM) trained and retrained (e.g., using machine learning) to have an overall understanding about operations performed on the system. The system AI agent provides a user interface to the LLM for receiving user queries to request answers about problems experienced with system operations. The user query, for instance, supports natural language inputs that can be plainly stated in a human language to convey a high level question about the problem. The user query can also be silent about domain function dependencies, e.g., does not provide insight in what domains, if any, are involved in the potential root cause. Based on user queries, the LLM of the system AI agent automatically identifies one or more domain functions, upon which, a problematic system operation depends. For example, the system AI agent processes the user query into one or more domain level queries.

Each domain AI agent provides a machine interface to its own LLM that is trained and retrained to employ detailed knowledge about the specific functions performed by that specific domain. At the direction of the system AI agent, the LLM of one or more of the domain AI agents automatically investigates potential causes of performance issues with the domain functions inferred from the domain level queries. For example, the machine interface of each domain AI agent receives the domain level queries generated by the system AI agent to request answers about problems experienced with system operations and/or domain functions.

In some examples, each domain agent works independently to respond to a domain query with an answer that is returned to the global agent. In this scenario, the domain AI agents are restricted from querying other domain AI agents. The system AI agent coordinates a root cause analysis of a system operation by querying the machine interface of a first domain AI agent. Based on an unsatisfactory response from the first domain AI agent, the system AI agent further coordinates the investigation by querying the machine interface of a second domain AI agent.

Based on a response from the second domain AI agent, the system AI agent generates a response to the user query.

In some implementations, the domain AI agents are configured to query other domain AI agents. For example, if a domain AI agent is incapable of generating an answer to a domain query, that domain agent may itself (or suggest the system AI agent) query another domain AI agent it has reason to believe can provide an answer, e.g., which is discerned using machine learning. The system AI agent, for instance, initiates a root cause analysis of a system operation by first querying the machine interface of a first domain AI agent. The first domain AI agent then queries the machine interface of a second domain AI agent to generate a response.

The system AI agent correlates responses received from each of the domain agents into a final response, which is then output via the user interface as a response to the user query. This coordination provided by the system AI agent preserves privileges and specialized knowledge across different domains. Different domains, for instance, may use similar terminology for different functionalities and therefore the specialized knowledge supports insights into these different uses. The system AI agent, in one or more implementations, therefore, employs general knowledge about the different domains, solely, whereas each individual domain retains control over the knowledge provided by its respective domain AI agent.

In this way, debugging distributed systems as described herein using multiple agent automated root cause analysis techniques operates faster and has increased computational efficiency than debugging a distributed system using conventional techniques. Providing answers to system problems is simplified and occurs without delay, which increases user satisfaction and decreases maintenance and support costs with increased runtime. In addition, the system AI agent user interface can be configured to output insights into the debugging process by displaying (e.g., in real time) domain queries being input to the domain AI agents, along with their corresponding responses. Providing intermediary results (e.g., feedback) obtained from the different domain AI agents improves confidence in the system AI agent solution. Further discussion of these and other examples is described in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Multiple Agent Automatic Root Cause Analysis Environment

FIG. 1 is an illustration of an environment 100 in an example implementation that is operable to employ multiple agent automatic root cause analysis techniques described herein. The illustrated environment 100 includes a distributed system 102 and a client device 104 that are communicatively coupled, one to another, via a network 106. Computing devices, which are also referred to as computing systems, that implement the distributed system 102 and the client device 104 are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low resource device with limited memory and/or processing resources (e.g., mobile devices). Additionally, although a single computing device is shown, a computing device is also representative of a plurality of different devices, such as multiple servers utilized by a business to perform operations “over the cloud” as described in FIG. 10.

The client device 104 includes a communication module 108 that is representative of functionality to communicate via the network 106 with a system manager module 110 of the distributed system 102, e.g., as a browser, a network enabled application, and so on. The system manager module 110 is configured to implement one or more system operations 112 using hardware and software resources of the distributed system 102, e.g., a processing device and a computer-readable storage medium. For example, the system manager module 110 executes the system operations 112 for access by the client device 104 via the network 106, e.g., as one or more digital services.

In executing the system operations 112, the system manager module 110 exposes the client device 104 to a plurality of domain manager modules that perform domain functions which are dependencies (i.e., dependent functions) of the system operations 112. For example, execution of the system operations 112 depends on successful execution of one or more respective domain functions executed by domain manager modules within one or multiple domains. Examples of the domain manager modules are illustrated as domain manger module 114(1) through domain manager module 114(N), which execute domain functions 116(1) through domain functions 116(N). The domain manager modules 114(1)-114(N) implement a plurality of computing domains (e.g., in a cloud network). For example, using hardware and software resources of the distributed system 102, e.g., a processing device and a computer-readable storage medium, a domain manager module 114(1) executes one or more domain functions 116(1), and a domain manager module 114(N) to execute one or more domain functions 116(N). Execution of the domain functions 116(1)-116(N) supports execution of the system operations 112.

Imagine a cloud storage application executing on the distributed system 102, which is made available via the network 106 to the client device 104. During its execution, the cloud storage application executes various tasks in furtherance of providing cloud storage services. The cloud storage application invokes one or more of the system operations 112 to perform these tasks, for example, to allow users to securely access and manage their data from data stores maintained within the distributed system 102.

The cloud storage application accesses an application program interface (API) of the system manager module 110. From the API, the cloud storage application requests a provisioning of a data stream over the network 106 to facilitate data transfers between the client device 104 and the distributed system 102, which allows the client device 104 to utilize the application's services. The system manager module 110 executes at least one of the system operations 112 to cause a provisioning of the data stream.

In response to executing the provisioning operation of the system operations 112, the system manager module 110 causes an invocation of one or more of the domain functions 116(1). For example, the domain manager module 114(1) may manage security of the system operations 112 to ensure privacy of data, privacy of data streams, and to prevent malicious access by unauthorized users. The provisioning operation of the system operations 112 is conditioned on successful validation of the client device 104 and/or the user of the client device 104. The domain manager module 114(1) executes the domain function 116(1) to verify that the client device 104 and/or the user have valid credentials for accessing the cloud storage application and the data maintained within the distributed system 102. If the domain function 116(1) fails to validate or invalidate the user of the client device 104, the provisioning operation of the system operations 112 also fails.

In further response to executing the provisioning operation of the system operations 112, the system manager module 110 causes an invocation of the domain functions 116(N). For example, the domain manager module 114(N) is responsible for implementing and managing streams provisioned on the network 106. The system manager module 110 can execute the provisioning operation of the system operations 112 to request a new stream on the network 106, however, the domain manager module 114(N) executes the domain functions 116(N) that open the stream and maintain the stream. By executing the domain functions 116(N), the domain manager module 114(N) ensures reliability of streams opened in the network 106 to ensure data is exchanged seamlessly between the client device 104 and the distributed system 102 without causing interference or data corruption between two different streams. The domain manager module 114(N) may refrain from opening a new stream, however, if the domain function 116(1) fails. The domain manager module 114(N) does not provision data streams on the network 106 for unauthorized actors. In this way, the provisioning operation of the system operations 112 is conditioned on successful execution of the domain functions 116(1) and the domain functions 116(N).

Cloud storage services are one example of digital services implemented through execution of the system operations 112. In some implementations, the system operations 112 support various other digital services, e.g., social media services, digital content creation services, streaming services, digital content storage services, online merchant services, and so forth. The system operations 112 aid in processing data objects, e.g., a keyspace, an event, a workflow, an application, a stream, a resource. As some examples, the system operations 112 enable uploads, downloads, creations, publications, exchanges, purchases, or other processes that utilize data objects of the services.

The system operations 112 depend on the domain functions 116(1)-116(N) to perform specific acts in furtherance of the processes that utilize the data objects of the services. As some examples, the domain functions 116(1)-116(N) enable provisioning, decommissioning, creating, modifying, configuring, encrypting, rendering, and other functions on the data objects within a particular domain of the distributed system 102.

The system manager module 110 includes a system AI agent module 118. The domain manager modules 114(1)-114(N) include corresponding domain AI agent modules, which are depicted in FIG. 1 as a domain AI agent module 120(1) of the domain manager module 114(1), and a domain AI agent module 120(N) of the domain manager module 114(N).

The system AI agent module 118 and the domain AI agent modules 120(1)-120(N) are implemented by respective machine learning models that execute on the computing devices of the distributed system 102 to respond to queries about performance issues with the system operations 112. In particular, the machine learning models of the system AI agent module 118 and the domain AI agent modules 120(1)-120(N) represent AI neural networks, which in some implementations are LLM type neural networks. For example, as individual LLMs, the system AI agent module 118 and the domain AI agent modules 120(1)-120(N) are configured to interpret general purpose language (e.g., from text documents, images, other sources) for learning statistical relationships associated with the language during computationally intensive self-supervised and semi-supervised training processes.

The system AI agent module 118 may be trained (e.g., supervised, self-supervised) or programmed with system data 124 maintained in a system storage device 122, e.g., a computer-readable storage media. The system data 124 (e.g., text documents, data files) relates to and supports the system operations 112 available on the distributed system 102. The domain AI agent modules 120(1)-120(N) are likewise trained (e.g., supervised, self-supervised) or programmed with domain data 128(1)-128(N) maintained in respective domain storage devices 126(1)-126(N). The domain data 128(1)-128(N) (e.g., text documents) relates to respective domain functions 116(1)-116(N) available on the distributed system 102. For example, the domain AI agent module 120(1) accesses domain data 128(1) stored in the domain storage device 126(1), including information about the domain functions 116(1) controlled by the domain manager module 114(1). The domain AI agent module 120(N) accesses domain data 128(N) stored in the domain storage device 126(N), including information about the domain functions 116(N) controlled by the domain manager module 114(N).

The LLM of the system AI agent module 118 executes in the distributed system 102 to respond to queries based on the overall understanding about the system operations 112 inferred from the system data 124. The system AI agent module 118 is configured to autonomously process received system level queries into one or more domain level queries. For example, based on the queries received by the system AI agent module 118, the LLM of the system AI agent module 118 automatically identifies one or more of the domain functions 116(1)-116(N) on which one or more of the system operations 112 inferred from the queries depend.

At the direction of the system AI agent module 118, LLMs of the domain AI agent modules 120(1)-120(N) autonomously investigates causes of performance issues with the domain functions 116(1)-116(N) inferred from the domain level queries. Potential reasons for the issues are obtained by the LLMs of the domain AI agent modules 120(1)-120(N) based on the detailed knowledge about the domain functions 116(1)-116(N) determined from the domain data 128(1)-128(N), which are performed by that specific domain in furtherance of the system operations 112.

As shown as displayed at the client device 104, for instance, the system AI agent module 118 controls a user interface 130. The user interface 130 is configured to receive an input from a user of the client device 104 in the form of a user query 132. The user interface 130 is configured to output a response 134 to the user query 132 generated by the system AI agent module 118 in the form of an answer to the question inferred from the user query 132. For example, the client device 104 outputs text of the user query 132, e.g., a question from the user about problems experienced with one or more of the system operations 112. The user query 132 can be plainly stated in a human language to convey a high level question about the problem the user is investigating. The user query 132 can also be silent about any dependencies already known to one or more of the domain functions 116(1)-116(N). Then, when the system AI agent module 118 generates a response 134 to the user query 132, the client device 104 outputs text of the response 134 (e.g., an answer to the question from the user that indicates one or more problems experienced with the domain functions 116(1)-116(N) that support the system operations 112 investigated in response to the user query 132).

To determine the response 134 to the user query 132, the system AI agent module 118 generates individual domain queries for receipt by one or more of the domain AI agent modules 120(1)-120(N). For example, each of the domain AI agent modules 120(1)-120(N) has a machine interface configured to receive domain level queries generated by the system AI agent module 118 to request answers about problems experienced with the system operations 112 and/or the domain functions 116(1)-116(N). In some implementations, the system AI agent module 118 updates the user interface 130 to reflect feedback 136 about the investigation process being performed to resolve the problem identified from the user query 132. For example, text is displayed in the user interface 130 to provide the user of the client device 104 with insight into the domain level queries sent to the domain AI agent modules 120(1)-120(N) and/or the domain level responses received from the domain AI agent modules 120(1)-120(N) in response to the domain level queries. The feedback 136 boosts user confidence in the accuracy of the response 134. The response 134 enables performance of the system operations 112 for troubleshooting to a root cause attributed to one or more of the domain functions 116(1)-116(N).

Accordingly, debugging the distributed system 102 using multiple agent automated root cause analysis techniques as provided by the system AI agent module 118 and the domain AI agent modules 120(1)-120(N) is less time consuming and cheaper than manually debugging the distributed system 102 using conventional techniques. Providing the response 134 to system problems identified from the user query 132 is simplified and occurs without delay (e.g., in near real time), which increases user satisfaction and decreases maintenance and support costs. In addition, the user interface 130 can be configured to output insights into the debugging process by displaying (e.g., in real time) domain queries being input to the domain AI agent modules 120(1)-120(N), along with their corresponding responses. Providing intermediary results (e.g., the feedback 136) obtained from the domain AI agent modules 120(1)-120(N) improves confidence in the solution, e.g., the response 134.

As used herein, the term “machine-learning model” refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model of the system AI agent module 118 and the domain AI agent modules 120(1)-120(N) are configured using a plurality of layers having, respectively, a plurality of nodes. The plurality of layers are configurable to include an input layer, an output layer, and one or more hidden layers. Calculations are performed by the nodes within the layers via hidden states through a system of weighted connections that are “learned” during training and retraining of the machine-learning model to implement a variety of tasks.

In order to train the machine-learning model, training data (e.g., the system data 124 for the system AI agent module 118, the domain data 128(1) for the domain AI agent module 120(1), the domain data 128(N) for the domain AI agent module 120(N)) is received that provides examples of “what is to be learned” by that respective machine-learning model, i.e., as a basis to learn patterns from the data. The machine-learning model of the system AI agent module 118, for instance, collects and preprocesses the system data 124 as training data that includes input features and corresponding target labels, i.e., of what is exhibited by the input features. The machine-learning model of the system AI agent module 118 then initializes parameters of its machine-learning model, which are used by its machine-learning model as internal variables to represent and process information during training and represent interferences gained through training. In an implementation, the training data for the machine-learning models described herein is separated into batches to improve processing and optimization efficiency of the parameters during training.

Training data is then received as an input by each machine-learning model and used as a basis for generating predictions based on a current state of parameters of layers and corresponding nodes, a result of which is output as output data. Output data describes an outcome of the task, e.g., as a probability of being a member of a particular class in a classification scenario.

Training of the machine-learning models described herein includes calculating a loss function to quantify a loss associated with operations performed by nodes of the machine-learning models. The calculating of the loss function, for instance, includes comparing a difference between predictions specified in the output data with target labels specified by the training data. The loss function is configurable in a variety of ways, examples of which include regret, Quadratic loss function as part of a least squares technique, and so forth.

Calculation of the loss function also includes use a backpropagation operation as part of minimizing the loss function and thereby training parameters of the machine-learning model. Minimizing the loss function, for instance, includes adjusting weights of the nodes in order to minimize the loss and thereby optimize performance of the machine-learning model in performance of a particular task. The adjustment is determined by computing a gradient of the loss function, which indicates a direction to be used in order to adjust the parameters to minimize the loss. The parameters of the machine-learning model are then updated based on the computed gradient.

This process continues over a plurality of iteration in an example until a stopping criterion is met. The stopping criterion is employed by the machine-learning models in this example to reduce overfitting of the machine-learning models, reduce computational resource consumption, and promote an ability of the machine-learning models to address previously unseen data, i.e., that is not included specifically as an example in the training data. Examples of a stopping criterion include but are not limited to a predefined number of epochs, validation loss stabilization, achievement of a performance improvement threshold, or based on performance metrics such as precision and recall.

Configuration of the training data is usable to support a variety of usage scenarios. In one example, the training data is configured as the system data 124 for the machine-learning model of the system AI agent module 118. The system data 124 includes dependencies of the system operations 112, historical issues encountered with the system operations 112, and historical resolutions to the issues previously experienced with the system operations 112. In this way, the system data 124 trains the machine-learning module of the system AI agent module 118 to efficiently predict which of the domain functions 116(1)-116(N) is likely a cause of a performance issue encountered with one or more of the system operations 112.

In other examples, the training data is configured as the domain data 128(1)-128(N) for the respective machine-learning model of the domain AI agent modules 120(1)-120(N). For example, the domain data 128(1) includes dependencies of the system operations 112, dependencies of the domain functions 116(1), historical issues encountered with the domain functions 116(1), and historical resolutions to the issues previously experienced with the domain functions 116(1). In this way, the domain data 128(1) trains the machine-learning module of the domain AI agent module 120(1) to efficiently predict which of the domain functions 116(1) and/or which of the domain functions 116(N) is likely a cause of a performance issue encountered with one or more of the system operations 112 and/or the domain functions 116(1).

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the combinations represented by the enumerated examples in this description.

### Example Multiple Agent Automatic Root Cause Analysis Techniques

The following discussion describes multiple agent automatic root cause analysis techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. For ease of description, the techniques are described with reference back to the environment 100 of FIG. 1.

FIG. 2 depicts an example dependency tree 200 of domain functions that support execution of an operation performed by a distributed system as described herein. An operation 112(1) is depicted in FIG. 2 as an example of one or more of the system operations 112 depicted in FIG. 1. The system manager module 110 executes the system operation 112(1) within the distributed system 102.

In this example, the execution of the system operation 112(1) is dependent on execution of several of the domain functions 116(1)-116(N) that are executed by the domain manager modules 114(1)-114(N). For example, the system operation 112(1) is executed to enable the client device 104 to access an online merchant service implemented on the distributed system 102. The system operation 112(1) invokes several of the domain functions 116(1)-116(N) to ensure the access is authorized and does not impact other services provided on the distributed system 102.

The system operation 112(1) is dependent on execution of the domain function 116(1) within the domain manager module 114(1). For example, the domain function 116(1) checks credentials of the client device 104 to allow or prevent access to the online merchant service.

In addition, the system operation 112(1) is dependent on execution of a domain function 116(2) within a domain manager module 114(2). For instance, the domain function 116(2) provisions a keyspace within the online merchant service to enable transactions between the client device 104 and the online merchant service. This dependency of the system operation 112(1) may be a direct dependency or indirect. For instance, execution of the system operation 112(1) invokes the domain function 116(1) separately from invoking the domain function 116(2). In other examples, execution of the system operation 112(1) invokes the domain function 116(1), and the domain function 116(1) invokes the domain function 116(2). In this way, execution of the system operation 112(1) within the distributed system 102 may be dependent on execution of the domain function 116(2) within the domain manager module 114(2). In other cases, execution of the system operation 112(1) within the distributed system 102 may be dependent on execution of the domain function 116(1) within the domain manager module 114(1), which is dependent on execution of the domain function 116(2) within the domain manager module 114(2).

As further depicted in FIG. 2, the system operation 112(1) is dependent on execution of a domain function 116(3) within a domain manager module 114(3). For example, the domain function 116(3) creates a stream between the online merchant service and the client device 104 to facilitate data transfers occurring between the client device 104 and the distributed system 102 in furtherance of the online merchant service.

In addition, the system operation 112(1) is dependent on execution of the domain function 116(N) within the domain manager module 114(N). For example, the domain function 116(4) monitors the stream opened by the domain function 116(3) to ensure reliability and high quality of services experienced by the client device 104 when accessing the online merchant service. As described above, these dependencies of the system operation 112(1) may be direct dependencies or indirect dependencies invoked because of the execution of the domain function 116(1) and/or the domain function 116(2).

Troubleshooting performance of the system operation 112(1) manually and/or utilizing conventional techniques can involve individually checking functionality of each of the domain manager modules 114(1)-114(N) (e.g., one at a time) to identify a root cause. Instead, multiple agent automated root cause analysis techniques are performed by the system AI agent module 118 and the domain AI agent modules 120(1)-120(N) to autonomously inspect performance of the domain functions 116(1)-116(N) to which the system operation 112(1) depends, individually.

FIG. 3 depicts a system 300 in an example implementation showing operations of a system agent and a plurality of domain agents that are operable to employ multiple agent automatic root cause analysis techniques as described herein. The system 300 depicts operations performed for producing elements for the user interface 130. For example, the response 134 is generated in reply to the system AI agent module 118 receiving the user query 132 from interactions between the client device 104 and the user interface 130. Generation of the response 134 includes providing the feedback 136 to impart confidence in the response 134.

The user query 132 pertaining to an operation 112(2) involving performance of the distributed system 102 is received by the system AI agent module 118. For example, the user query 132 requests information about why a request from the client device 104 to access user data maintained by a cloud storage service has failed. The LLM of the system AI agent module 118 parses text of the user query 132 to identify the system operation 112(2) as being at least one of the system operations 112 that causes a provisioning of a data stream for the cloud storage service.

An indication of feedback 136(1) is output in the user interface 130 to convey that the system operation 112(2) and purpose for the user query 132 are correctly understood by the LLM of the system AI agent module 118. The system AI agent module 118 determines that the domain function 116(1) is performed by the domain AI agent module 120(1) in furtherance of the system operation 112(2) based on knowledge of the distributed system 102, which the LLM obtains from the system data 124.

In conjunction with the feedback 136(1), the system AI agent module 118 issues a domain query 302 to a machine-interface of the LLM of the domain AI agent module 120(1). The domain query 302 requests status, information, or other feedback about performance of the domain function 116(1) as it relates to execution of the system operation 112(2). For example, the domain function 116(1) is executed to provision a stream on the network 106. The LLM of the domain AI agent module 120(1) parses text of the domain query 302 to identify the domain function 116(1) to which the system operation 112(2) depends. Based on knowledge the LLM obtains from the domain data 128(1), the domain AI agent module 120(1) outputs a domain response 304. The domain response 304 indicates that the performance issue with the system operation 112(2) is not caused by the domain function 116(1), but rather, the domain response 304 implicates a domain function 116(2), which is performed by a domain AI agent module 120(2). For example, the domain function 116(2) is executed to verify that the client device 104 and/or the user have valid credentials for accessing the cloud storage application before the domain function 116(1) is allowed to provision the data stream for the cloud storage service. Based on the domain response 304, the system AI agent module 118 determines that the domain function 116(2) is performed by the domain AI agent module 120(2) in furtherance of the system operation 112(2). Another indication of feedback 136(2) is output in the user interface 130 to convey that the domain function 116(1) is not likely a source of the problem with the system operation 112(2), and that the domain function 116(2) may be the culprit.

Along with the feedback 136(2), the system AI agent module 118 issues a domain query 306 to a machine-interface of the LLM of the domain AI agent module 120(2). The domain query 306 requests status, information, or other feedback about performance of the domain function 116(2) as it relates to execution of the system operation 112(2). The LLM of the domain AI agent module 120(2) parses text of the domain query 306 to identify the domain function 116(2) to which the system operation 112(2) depends. Based on knowledge the LLM obtains from domain data 128(2), the domain AI agent module 120(2) outputs a domain response 308, which suggests that the domain function 116(N) may be a root cause of the problem with the system operation 112(2). For example, the domain function 116(N) implements one of the several security checks initiated by the domain function 116(2) to verify whether the credentials for accessing the cloud storage application are valid. The domain function 116(N) may check encryption tokens exchanged between the client device 104 and the distributed system 102.

Based on the domain response 308, the system AI agent module 118 determines that the domain function 116(N) is performed by the domain AI agent module 120(N) in furtherance of the system operation 112(2). A third indication of feedback 136(N) is output in the user interface 130 to convey that the domain function 116(2) is not likely a source of the problem with the system operation 112(2), and that the domain function 116(N) may be the culprit.

In furtherance of outputting the feedback 136(N), the system AI agent module 118 issues a domain query 310 to a machine-interface of the LLM of the domain AI agent module 120(N). The domain query 310 requests status, information, or other feedback about performance of the domain function 116(N) as it relates to execution of the system operation 112(2). The LLM of the domain AI agent module 120(N) parses text of the domain query 310 to identify the domain function 116(N) to which the system operation 112(2) depends. Based on knowledge the LLM obtains from the domain data 128(N), the domain AI agent module 120(N) outputs a domain response 312, which suggests that the domain function 116(N) is a root cause of the problem with the system operation 112(2).

Then, the system AI agent module 118 updates the user interface 130 to respond to the user query 132. Using machine learning and the knowledge obtained from the system data 124 and the domain responses 304, 308, and 312, the system AI agent module 118 outputs the response 134 within the user interface 130. From the user interface 130, the response 134 indicates an issue with the system operation 112(2), which is caused by the domain function 116(N) and not the domain function 116(1) or the domain function 116(2). For example, the response 134 indicates a corrupt token state exists between the client device 104 and the distributed system 102.

FIG. 4 depicts a system 400 in another example implementation showing operations of a system agent and a plurality of domain agents that are operable to employ multiple agent automatic root cause analysis techniques as described herein. The system 400 depicts a similar construction process for producing elements for the user interface 130 as depicted in FIG. 3. For example, in response to the system AI agent module 118 receiving the user query 132 from interactions between the client device 104 and the user interface 130, the response 134 is generated. Instead of successively issuing domain queries to the individual domain AI agent modules 120(1)-120(N), however, the system AI agent module 118 issues only one domain query, and the domain AI agent modules 120(1)-120(N) autonomously issue further domain queries to other domain AI agent modules 120(1)-120(N).

The user query 132 pertaining to an operation 112(3) involving performance of the distributed system 102 is received by the system AI agent module 118. The LLM of the system AI agent module 118 parses text of the user query 132 to identify the system operation 112(3).

The feedback 136(1) is output in the user interface 130 to convey that the system operation 112(3) and purpose for the user query 132 are correctly understood by the LLM of the system AI agent module 118. The system AI agent module 118 determines that the domain function 116(1) is performed by the domain AI agent module 120(1) in furtherance of the system operation 112(3) based on knowledge of the distributed system 102, which the LLM obtains from the system data 124.

Then, the system AI agent module 118 issues a domain query 402 to the machine-interface of the LLM of the domain AI agent module 120(1) to request information about performance of the domain function 116(1) as it relates to execution of the system operation 112(3). The LLM of the domain AI agent module 120(1) parses text of the domain query 402 and based on knowledge the LLM obtains from the domain data 128(1), the domain AI agent module 120(1) outputs a domain query 404 to check if the performance issue with the system operation 112(3) is caused by the domain function 116(N), and not the domain function 116(1) as suspected by the system AI agent module 118.

The domain query 404 is output for receipt by a machine-interface of the LLM of the domain AI agent module 120(N). The domain query 404 requests status, information, or other feedback about performance of the domain function 116(N) as it relates to execution of the system operation 112(3). The LLM of the domain AI agent module 120(N) parses text of the domain query 404 to identify the domain function 116(N) to which the system operation 112(3) depends. Based on knowledge the LLM obtains from the domain data 128(N), the domain AI agent module 120(N) outputs a domain response 406, which suggests that the domain function 116(N) is a root cause of the problem with the system operation 112(3).

Then, the system AI agent module 118 updates the user interface 130 to respond to the user query 132. The system AI agent module 118 outputs the response 134 generated using machine learning and the knowledge obtained from the system data 124 and the domain response 406 within the user interface 130.

FIG. 5 depicts a system 500 in an example implementation showing operation of a system agent of FIG. 1 in greater detail. The system 500 represents a system manager module, which is an example implementation of the system manager module 110.

In addition to the elements of the system manager module 110 as depicted in FIG. 1, the system 500 includes a domain agent registrar 502. The system 500 is configured to register each of the domain AI agent modules 120(1)-120(N) to be associated with a different domain from the plurality of domains of the distributed system 102. The domain agent registrar 502 enables each of the domain AI agent modules 120(1)-120(N) to request registration with the system AI agent module 118 for assisting with troubleshooting performance of the system operations 112. The system data 124 within the system storage device 122 maintains the domain agent registrar 502, which indicates specific domain AI agent modules 120(1)-120(N) within the distributed system 102 that are available to assist the LLM of the system AI agent module 118. The system AI agent module 118 generates domain queries to the domain AI agent modules 120(1)-120(N) within the domain agent registrar 502, and refrains from sending domain queries to domain AI agent modules 120(1)-120(N) that are excluded from this record. In this way, privacy and security across the domains of the distributed system 102 are protected. Those domains that have pre-registered with the system AI agent module 118 are available, solely, for implementing the user interface 130 in this example.

The system 500 also includes a record of operation dependencies 504. The system 500 is configured to maintain the operation dependencies 504 to improve efficiency in determining which of the domain functions 116(1)-116(N) may be implicated in a user query about a particular one of the system operations 112. From the operation dependencies 504, the system AI agent module 118 is configured to obtain a first listing of first available functions from a first domain including at least one first dependent operation corresponding to each of the first available functions. Likewise, the system AI agent module 118 is configured to obtain from the operation dependencies 504 a second listing of second available functions from a second domain including at least one second dependent operation corresponding to each of the second available functions, and so forth.

The system data 124 within the system storage device 122 maintains the operation dependencies 504 for quick access during execution of the system AI agent module 118. For example, when a user query about the system operation 112(1) is received, the LLM of the system AI agent module 118 can rely on the operation dependencies 504 listed for the system operation 112(1) as a starting point in debugging an issue that is learned as part of training the LLM. In following the example of FIG. 2 that depicts the dependencies of the system operation 112(1), the operation dependencies 504 indicate that the domain function 116(1), the domain function 116(2), the domain function 116(3), and the domain function 116(N) are possible causes of poor performance.

FIG. 6 depicts a system 600 in an example implementation showing a domain agent of FIG. 1 in greater detail. The system 600 represents a domain manager module, which is an example implementation of any of the domain manager modules 114(1)-114(N).

In addition to the elements of the domain manager modules 114(1)-114(N) as depicted in FIG. 1, the system 600 includes domain privileges 602. The domain privileges 602 preserve security and protection across the multiple domains of the distributed system 102 by restricting some of the domain AI agent modules 120(1)-120(N) from having knowledge and/or from querying others of the domain AI agent modules 120(1)-120(N). For example, the system 600 includes the domain privileges 602 as a set of privileges that restrict the domain AI agent module 120(N) from accessing the domain data 128(1). In other cases, the system 600 includes domain privileges 602 as a set of privileges that restrict the domain AI agent module 120(1) from accessing the domain data 128(N). In some examples, the domain privileges 602 include privileges for accessing other domains. For example, the system 600 includes the domain privileges 602 as set of privileges that allow the domain AI agent module 120(N) to access the domain data 128(1) but prevent access to the domain data 128(N) of another one of the domain AI agent modules 120(1)-120(N).

The system 600 also includes function dependencies 604. Similar to the how the operation dependencies 504 are used in the system 500, the domain data 128(1)-128(N) within the storage devices 126(1)-126(N) maintain the function dependencies 604 for quick access during execution of the domain AI agent modules 120(1)-120(N). For example, when a domain query about the domain function 116(1) is received, the LLM of the domain AI agent module 120(1) can rely on the function dependencies 604 listed for the system operation 112(1) and/or the domain function 116(1) as a starting point in debugging an issue inferred from the user query 132. In following the example of FIG. 4 that depicts the dependencies of the system operation 112(3), the function dependencies 604 indicate that the domain function 116(N) is a possible cause of poor performance with the system operation 112(3) and/or the domain function 116(1).

FIG. 7 illustrates an example user interface 700 showing interactions between a client device and a system agent that is operable to employ multiple agent automatic root cause analysis techniques as described herein. The user interface 700 is an example of the user interface 130 and is described as being displayed on the client device 104 in the context of the environment 100 depicted in FIG. 1.

In the user interface 700, a series of graphical indications depicted in FIG. 8 as indication 702 through indication 712. The indication 702 through the indication 712 each provide information (e.g., text) indicating one or more of the user query 132, the response 134, or the feedback 136 provided along the way as the system AI agent module 118 and the domain AI agent modules 120(1)-120(N) derive the response 134.

Within the indication 702, the LLM of the system AI agent module 118 prompts a user of the client device 104 to convey their question about performance of one or more of the system operations 112. The interface to the LLM of the system AI agent module 118 receives the user query 132 from interactions by the client device 104 in response to the prompt.

Within an indication 704, the LLM of the system AI agent module 118 provides feedback to give the user of the client device 104 confidence in the LLM understanding the user query 132, including an identity of one of the system operations 112 understood to be a subject of an investigation. For example, the system AI agent module 118 formats the user query 132 for input to the LLM of the system AI agent module 118, which may be similar to the text of the user query 132 or may be a modification of that text to put the user query 132 into a recognizable sentence structure of the LLM.

Next, the user interface 700 provides an indication 706. From the indication 706, the feedback 136 obtained from investigating the issue of the user query 132 is conveyed. For example, the system AI agent module 118 outputs an identifier (e.g., a name) of the domain function 116(1) (e.g., “function X”) and the domain function 116(N) (e.g., “function Y”) as being dependent functions of the system operation 112(3).

Within the indication 706, the system AI agent module 118 also displays results of queries submitted to the domain AI agent modules 120(1)-120(N). For example, the system AI agent module 118 generates a first domain query that is formatted for input to the LLM of the domain AI agent module 120(1). In addition, the system AI agent module 118 formats a second domain query for input to the LLM of the domain AI agent module 120(N).

Within the indication 708, the system AI agent module 118 displays the response 134 derived from the domain responses received from the domain AI agent modules 120(1)-120(N) based on the domain queries provided to them. For example, the LLM of the system AI agent module 118 generates the response 134 to the user query 132 to indicate the issue is caused by the domain function 116(2) and not the domain function 116(1). In other cases where more than one of the domain functions 116(1)-116(N) is a source of a problem, the LLM of the system AI agent module 118 generates the response 134 to the user query 132 to indicate the issue is caused by the domain function 116(1) and the domain function 116(2).

To improve future analysis performed by the system AI agent module 118 (e.g., as part of the machine learning executed by the LLM of the system AI agent module 118), user feedback is requested within the indication 710. The user feedback requested in the indication 710 may ask for confirmation that the response 134 is satisfactory. As depicted, the indication 710 may pose a question to ask whether the user of the client device 104 requests help fixing the issue uncovered.

Within the indication 712, the system AI agent module 118 closes the investigation triggered by the user query 132. For example, the system AI agent module 118 uses the feedback obtained in the indication 710 to help train the LLM of the system AI agent module 118 based on the successful (or in other cases unsuccessful) resolution.

FIG. 8 is a flow diagram depicting a step-by-step procedure 800 in an example implementation of operations performable by a processing device for implementing multiple agent automatic root cause analysis techniques as described herein. In this example, the procedure 800 starts to troubleshoot performance of a system operation by a distributed system having a plurality of domains (block 802). For example, the user query 132 is received via the user interface 130 or the user interface 700 by the system AI agent module 118.

Which domains of the plurality of domains include domain functions in support of the system operation is determined (block 804). For example, the LLM of the system AI agent module 118 parses the user query 132 for an indication of one or more of the system operations 112. In response to determining the system operations 112 associated with the user query 132, the system AI agent module 118 checks the operation dependencies 504 and identifies one or more of the domain AI agent modules 120(1)-120(N) that are potentially responsible for executing one or more of the domain functions 116(1)-116(N) listed in the operation dependencies 504 to support one the system operations 112 inferred from the user query 132.

Queries to the determined domains based on the system operation are generated (block 806). For example, after determining that the domain function 116(N) is a dependent function of one of the system operations 112 that is the subject of the user query 132, the system AI agent module 118 verifies that the domain AI agent module 120(N) appears in the domain agent registrar 502. Upon confirming the domain AI agent module 120(N) is registered with the system AI agent module 118, a domain query about performance of the domain function 116(N) is input to the machine interface of the LLM associated with the domain AI agent module 120(N).

Domain responses from domain AI agents associated with the determined domains are received responsive to the queries and generated based on domain data associated with respective domains (block 808). For example, the system AI agent module 118 receives a domain response from the LLM of the domain AI agent module 120(N). The domain response indicates a performance issue with the domain function 116(N), or that there is not a performance issue with the domain function 116(N). In the latter case, the domain response may include a candidate domain and/or one of the domain functions 116(1)-116(N) to be checked instead.

A system response by the system AI agent using machine learning based on the domain responses is generated (block 810). For example, the system AI agent module 118 determines an answer to the user query 132 based on the received domain response to indicate a performance issue with the domain function 116(N) possibly causing the issue. In some examples, the response is output via the user interface as an answer to the user query. For example, the system AI agent module 118 formats the answer to the user query 132 to output the response 134 within the user interface 130 or the user interface 700.

FIG. 9 is a flow diagram depicting a step-by-step procedure 900 in an example implementation of operations performable by a processing device for implementing multiple agent automatic root cause analysis techniques as described herein. To begin this example, a user query configured to troubleshoot performance of a system operation in a distributed system having a plurality of domains is received (block 902). For example, the user query 132 is transmitted via the network 106 to the system manager module 110. The system AI agent module 118 may format the user query 132 for input to the LLM of the system AI agent module 118. For example, text or language of the user query 132 may be broken down by the system AI agent module 118 into a suitable question that is understandable by the LLM of the system AI agent module 118.

A first domain involving the performance of the system operation is determined (block 904). For example, the system AI agent module 118 analyzes the user query 132 to identify one or more of the system operations 112 as a subject of investigation.

From identifying the system operations 112, the system AI agent module 118 determines (e.g., from the operation dependencies 504) one or more of the domain functions 116(1)-116(N) as possible causes of a performance issue with the system operations 112.

In some example, this step is preceded by registering a domain AI agent from each of the computing domains. For example, a first domain AI agent and a second domain AI agent are listed in the domain agent registrar 502 as each being available domain AI agents for receiving domain queries in response to the user query 132. The operation dependencies 504 indicate the domain functions 116(1)-116(N) that are known by the domain AI agents. In some implementations, the operation dependencies 504 include a mapping between the domain functions 116(1)-116(N) and the system operations 112. The system AI agent module 118 may determine a first listing of first available functions from the first domain including at least one first dependent operation corresponding to each of the first available functions. The system AI agent module 118 may likewise determine a second listing of second available functions from the second domain including at least one second dependent operation corresponding to each of the second available functions. This facilitates the system AI agent module 118 to efficiently determine which of the domain functions 116(1)-116(N) that are candidates as causes of an issue.

A first query for receipt by a first domain AI agent of the first domain is generated (block 906). For example, the system AI agent module 118 generates the first domain query for display in the user interface 130 or the user interface 700 to provide the feedback 136 to the user of the client device 104 as the investigation progresses. The system AI agent module 118 may format the first domain query for input to a LLM of the domain AI agent module 120(1). This facilitates the domain AI agent module 120(1) upon receipt of the domain query to efficiently determine which of the domain functions 116(1)-116(N) that are reported as possible causes for an issue.

A first domain response from the first domain AI agent is received (block 908). For example, the LLM of the domain AI agent module 120(1) processes the domain query received from the system AI agent module 118 and determines from the function dependencies 604 other domains of the distributed system 102 that help with one of the system operations 112 at hand. In response to checking the domain data 128(1) and determining that none of the domain functions 116(1)-116(N) controlled by the domain manager module 114(1) are experiencing problems, the domain AI agent module 120(1) generates a domain response to the domain query for the system AI agent module 118 to learn that another domain may be implicated in the investigation. In some examples, the feedback 136 within the user interface 130 or the user interface 700 that is output for display includes an indication of the domain functions 116(1)-116(N) checked by the domain AI agent modules 120(1)-120(N) and its domain response.

A second query for receipt by a second domain AI agent of a second domain based on the first domain response is generated (block 910). For example, the system AI agent module 118 generates the second domain query for display in the user interface 130 or the user interface 700 to provide the feedback 136 to the user of the client device 104 as the investigation progresses. The system AI agent module 118 may format the second domain query for input to a LLM of the domain AI agent module 120(N). This facilitates the domain AI agent module 120(N) upon receipt of the domain query to efficiently determine which of the domain functions 116(1)-116(N) that are reported as possible causes for an issue.

A second domain response is received from the second domain AI agent (block 912). For example, the LLM of the domain AI agent module 120(N) processes the domain query received from the system AI agent module 118 and determines from the function dependencies 604 other domains of the distributed system 102 that support one of the system operations 112 being investigated. In response to checking the domain data 128(N) and determining that one or more of the domain functions 116(N) controlled by the domain manager module 114(N) are experiencing problems, the domain AI agent module 120(N) generates a domain response to the domain query for the system AI agent module 118 to learn of the domain functions 116(N), which may be implicated in the investigation. In some examples, the feedback 136 within the user interface 130 or the user interface 700 that is output for display includes an indication of the domain functions 116(N) checked by the domain AI agent module 120(N) and its domain response.

A system response to the user query, generated by the system AI agent based on the second domain response and the first domain response is output (block 914). For example, the system AI agent module 118 generates the response 134 to the user query 132 to indicate the issue is caused by the second function controlled by the domain manager module 114(N) and not the first function controlled by the domain manager module 114(1). In other cases, two domains and their respective domain functions 116(1)-116(N) are implicated. The system AI agent module 118 generates the response 134 to the user query 132 to indicate the issue is caused by the first function controlled by the domain manager module 114(1) and the second function controlled by the domain manager module 114(N). From the response 134 displayed in the user interface 130 or the user interface 700, the user of the client device 104 that submitted the user query 132 is able to quickly troubleshoot the specific domain functions 116(1)-116(N) causing their issue.

### Example System and Device

FIG. 10 illustrates an example system 1000 including various components of an example of one or more computing devices 1002 that can be implemented as any type of computing device as described and/or utilize with reference to the previous figures to implement embodiments of the techniques described herein. The computing devices 1002 are configurable, for example, as a server of a service provider, a device associated with a client (e.g., a client device), an on-chip system, and/or any other suitable computing device or computing system. The system 1000 is configured to provide a multi-agent service for troubleshooting the distributed system 102, autonomously and without user intervention.

The example computing devices 1002 as illustrated include a processing system 1004, one or more computer-readable media 1006, and one or more input/output interfaces 1008 that are communicatively coupled, one to another. Although not shown, the computing devices 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that are configurable as processors, functional blocks, and so forth. This includes implementation in hardware as an application specific integrated circuit or other logic device formed using one or more semiconductors. The hardware elements 1010 are not limited by the materials from which they are formed, or the processing mechanisms employed therein. For example, processors are configurable as semiconductor(s) and/or transistors (e.g., electronic integrated circuits (ICs)). In such a context, processor executable instructions are electronically executable instructions.

The computer-readable media 1006 is illustrated as including memory/storage 1012 that stores instructions that are executable to cause the processing system 1004 to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

The input/output interfaces 1008 are representative of functionality to allow a user to enter commands and information to the computing devices 1002 and allow information to be presented to the user and/or other components or devices using various input/output devices. Examples of input devices include a keyboard, a cursor control device (e.g., a mouse), a microphone, a scanner, touch functionality (e.g., capacitive sensors, other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile response device, and so forth. Thus, the computing devices 1002 are configurable in a variety of ways as further described below to support user interaction.

Various techniques are described herein in the general context of software, hardware elements, or program modules. Generally, such modules include routines, programs, objects, elements, components, data structures, and so forth that perform tasks or implement particular abstract data types. The terms “module,” “functionality,” and “component” as used herein generally represent software, firmware, hardware, or a combination thereof. The features of the techniques described herein are platform independent, meaning that the techniques are configurable on a variety of commercial computing platforms having a variety of processors.

An implementation of the described modules and techniques is stored on or transmitted across some form of computer-readable media. The computer-readable media 1006 includes a variety of media that is accessed by the computing devices 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal bearing medium that is configured to transmit instructions to the hardware of the computing devices 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application specific integrated circuit (ASIC), a field programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing devices 1002 are configured to implement instructions and/or functions corresponding to the software and/or hardware modules. Accordingly, implementation of a module that is executable by the computing devices 1002 as software is achieved at least partially in hardware, e.g., through use of computer-readable storage media and/or hardware elements 1010 of the processing system 1004. The instructions and/or functions are executable/operable by one or more articles of manufacture (for example, one or more of the computing devices 1002 and/or processing system 1004) to implement techniques, modules, and examples described herein.

The techniques described herein are supported by various configurations of the computing devices 1002 and are not limited to the specific examples of the techniques described herein. This functionality is also implementable all or in part through use of a distributed system, such as over a cloud 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include the distributed system 102 and all its applications and/or data that can be utilized while computer processing is executed on servers that are remote from the computing devices 1002. Resources 1018 can also include services provided by the distributed system over the network 106, in addition to over the Internet and/or through a subscriber network, such as a cellular or wireless protocol network (e.g., Wi-Fi).

The platform 1016 abstracts resources and functions to connect the computing devices 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing devices 1002 as well as via the platform 1016 that abstracts the functionality of the cloud 1014.

In implementations, the platform 1016 employs a “machine learning model” that is configured to implement the techniques described herein. A machine learning model refers to a computer representation that can be tuned (e.g., trained and retrained) based on inputs to approximate unknown functions. In particular, the term machine learning model can include a model that utilizes algorithms to learn from, and make predictions on, known data by analyzing training data to learn and relearn to generate outputs that reflect patterns and attributes of the training data. Examples of machine learning models include neural networks (e.g., an LLM), convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving a user query configured to troubleshoot performance of a system operation having a plurality of domains;
determining, by a system artificial intelligence (AI) agent using machine learning, a first domain involving the performance of the system operation;
generating, by the system AI agent, a first query for receipt by a first domain AI agent of the first domain;
receiving a first domain response from the first domain AI agent;
generating, by the system AI agent, a second query for receipt by a second domain AI agent of a second domain based on the first domain response;
receiving a second domain response from the second domain AI agent of the second domain; and
outputting a system response to the user query generated by the system AI agent based on the second domain response and the first domain response.

2. The method of claim 1, further comprising registering the first domain AI agent and the second domain AI agent to each be one of a plurality of domain AI agents available to the system AI agent for receiving domain queries.

3. The method of claim 2, wherein the registering the first domain AI agent comprises:
obtaining with the system AI agent a first listing of first available domain functions from the first domain including at least one first dependent system operation corresponding to each of the first available functions; and
obtaining with the system AI agent a second listing of second available domain functions from the second domain including at least one second dependent system operation corresponding to each of the second available domain functions.

4. The method of claim 1, wherein the performance of the system operation is dependent on execution of a first domain function within the first domain.

5. The method of claim 4, wherein the performance of the system operation is further dependent on execution of a second domain function within the second domain.

6. The method of claim 5, wherein execution of the first domain function is dependent on execution of the second domain function.

7. The method of claim 1, wherein:
the first domain includes a first set of privileges that restrict the first domain AI agent from accessing the second domain; and
the second domain includes a second set of privileges that restrict the second domain AI agent from accessing the first domain.

8. The method of claim 1, wherein the generating the first domain query further comprises generating the first domain query for display in a user interface for the system AI agent, and further comprising outputting the first domain response for display in the user interface.

9. The method of claim 8, wherein the generating the second domain query further comprises generating the second domain query for display in the user interface, and further comprising outputting the second domain response for display in the user interface.

10. The method of claim 1, further comprising generating the system response to the user query to indicate an issue is caused by the first domain and the second domain.

11. The method of claim 1, further comprising generating the system response to the user query to indicate an issue is caused by the second domain and not the first domain.

12. The method of claim 1, further comprising formatting the user query for input to a large language model of the system AI agent.

13. The method of claim 1, further comprising:
formatting the first domain query for input to a first large language model of the first domain AI agent; and
formatting the second domain query for input to second large language model of the second domain AI agent.

14. The method of claim 1, wherein the plurality of domains are implemented in a cloud network.

15. A system comprising:
a first domain artificial intelligence (AI) agent module trained via machine learning using first domain data associated with a first domain from a plurality of computing domains of the system to generate a first domain response to a first domain query about performance of a first domain function implemented by the first computing domain in furtherance of a system operation supported by the first domain function and at least one second domain function implemented by a second domain from the plurality of computing domains; and
a system AI agent module implemented by a machine learning model to generate the first domain query for receipt by the first domain AI agent to troubleshoot performance of the system operation and output a response that indicates an issue with the system operation based on the first domain response.

16. The system of claim 15, further comprising a second domain artificial intelligence (AI) agent module trained via machine learning using second domain data associated with the second domain to generate a second domain response to a second domain query about performance of the second domain function in furtherance of the system operation.

17. The system of claim 16, wherein the system AI agent module generates the second domain query for receipt by the second domain AI agent to troubleshoot performance of the operation, and outputs the response that indicates the issue with the system operation based on the first domain response and the second domain response.

18. The system of claim 16, wherein the first domain AI agent module generates the second domain query for receipt by the second domain AI agent to troubleshoot performance of the system operation, and outputs the second domain response to the system AI agent module.

19. A computing device comprising:
a processor; and
a computer-readable storage medium storing instructions that, responsive to execution by the processor, causes the processor to perform operations including:
troubleshooting performance of a system operation having a plurality of domains, the troubleshooting including:
determining, by a system artificial intelligence (AI) agent, which domains of the plurality of domains include domain functions in support of the system operation;
generating, by the system AI agent using machine learning, queries to the determined domains based on the system operation;
receiving domain responses from domain AI agents associated with the determined domains responsive to the queries, the domain responses generated based on domain data associated with respective domains; and
generating a system response by the system AI agent using machine learning based on the domain responses.

20. The computing device of claim 19, the troubleshooting further including outputting the system response for display in a user interface.
